(19) United States
(12) Patent Application Publication
(10) Pub. No.: US 2026/0219494 A1
(43) Pub. Date: Jul. 30, 2026

(54) VEHICULAR CAMERA ASSEMBLY WITH LENS HEATER

(71) Applicant: Magna Electronics Inc., Auburn Hills, MI (US)

(72) Inventors: Stefan Sauer, Waldaschaff (DE); Rene Dreiocker, Rochester Hills, MI (US); Steven V. Byrne, Goodrich, MI (US); Jonathan D. Conger, Huntington Woods, MI (US); Hugo Carillo, Rochester, MI (US)

(21) Appl. No.: 19/459,566

(22) Filed: Jan. 26, 2026

Related U.S. Application Data
(60) Provisional application No. 63/749,847, filed on Jan. 27, 2025.

(51) Int. Cl. G02B 27/00; B60S 1/02; H04N 23/54; H04N 23/55; H04N 23/57; H05B 3/84

(52) U.S. Cl. CPC G02B 27/0006; B60S 1/026; H04N 23/55; H05B 3/84; H04N 23/54; H04N 23/57; H05B 2203/016

(57) ABSTRACT

A vehicular camera assembly includes a lens barrel including a lens and disposed at a camera housing. An imager printed circuit board (imager PCB) includes an imager disposed at a first side. A heating device at the lens barrel includes an electrically connecting portion having electrical contact pads. Electrical contacts at the first side of the imager PCB are spaced from the electrical contact pads. An electrical bridge contact electrically connects between the electrical contact pads and the electrical contacts and includes spring-loaded electrical connectors that engage the electrical contact pads and the electrical contacts and apply a biasing force therebetween. The electrical bridge contact is not disposed between the electrical contact pads and the electrical contacts during adjustment of the imager relative to the lens to align the imager with the lens and before the imager is secured relative to the lens.

### CROSS REFERENCE TO RELATED APPLICATION

The present application claims the filing benefits of U.S. provisional application Ser. No. 63/749,847, filed Jan. 27, 2025, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A driving assistance system or vision system or imaging system for a vehicle utilizes one or more cameras (preferably one or more CMOS cameras) to capture image data representative of images exterior of the vehicle. The system may provide communication/data signals, including camera data or captured image data, that may be displayed at a display screen that is viewable by the driver of the vehicle, such as when the driver is backing up the vehicle, and that may be processed and, responsive to such image processing, the system may detect an object at or near the vehicle and in the path of travel of the vehicle, such as when the vehicle is backing up. The vision system may be operable to display a surround view or bird's eye view of the environment at or around or at least partially surrounding the subject or equipped vehicle, and the displayed image may include a displayed image representation of the subject vehicle.

A vehicular camera of the vision system may include a camera housing and a lens barrel accommodates a lens including a plurality of optical elements. The lens barrel is disposed at the camera housing. An imager printed circuit board (imager PCB) has a first side and a second side opposite the first side and separated by a thickness of the imager PCB. An imager is disposed at the first side of the imager PCB and the imager is aligned with the lens accommodated by the lens barrel. A heating device is disposed at the lens barrel and includes an electrically connecting portion having electrical contact pads. Electrical contacts are disposed at the first side of the imager PCB and are spaced from the electrical contact pads of the heating device. The heating device is electrically connected to circuitry of the vehicular camera assembly via an electrical bridge contact that electrically connects between the electrical contact pads and the electrical contacts at the first side of the imager PCB. The electrical bridge contact includes spring-loaded electrical connectors that (i) engage the electrical contact pads and the electrical contacts at the first side of the imager PCB and (ii) apply a biasing force between the electrical contact pads and the electrical contacts. The imager PCB is movable relative to the lens barrel to align the imager with the lens accommodated by the lens barrel. As the imager PCB and the lens barrel are moved relative to one another to align the imager with the lens accommodated by the lens barrel, the electrical bridge contact is not disposed between the electrical contact pads and the first side of the imager PCB. With the imager aligned with the lens accommodated by the lens barrel and with the imager PCB secured relative to the lens barrel to maintain alignment of the imager with the lens accommodated by the lens barrel, the electrical bridge contact is disposed between the electrical contact pads and the electrical contacts at the first side of the imager PCB to electrically connect the heating device to circuitry of the vehicular camera assembly. When the heating device is electrically operated via the circuitry of the vehicular camera assembly, the heating device heats the lens accommodated by the lens barrel.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of a camera of the vehicular vision system;

FIGS. 3 and 4 are schematic views of the camera, showing an electrical bridge contact electrically connecting a heating device of the camera to circuitry at the imager printed circuit board (imager PCB) of the camera;

FIG. 5 is a sectional view of the camera;

FIG. 6 is a schematic view of the camera, showing the electrical bridge contact being installed after the imager PCB is secured relative to the lens barrel of the camera; and

FIGS. 7 and 8 are perspective views of the electrical bridge contact.

### DESCRIPTION OF THE PREFERRED EMBODIMENTS

A vehicular vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

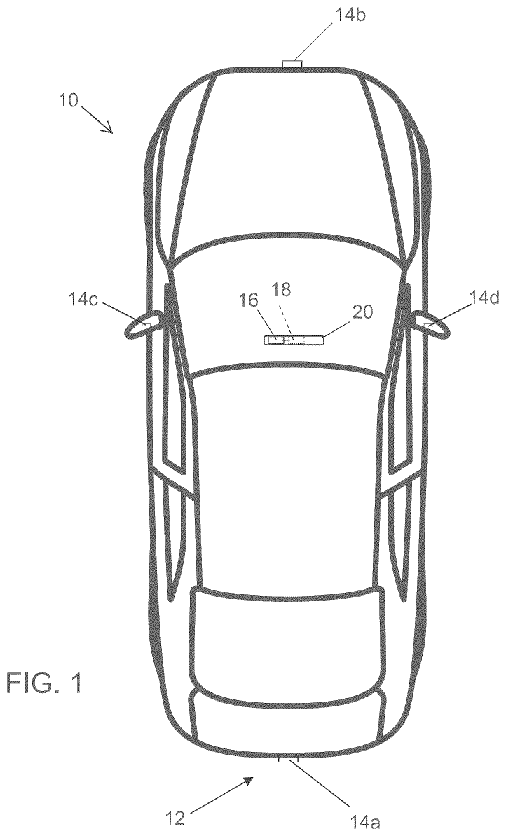

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Each exterior viewing camera 14 includes a housing and an imager and a lens that is oriented such that the camera 14 views exterior of the vehicle. Because at least an outer lens element of the camera is exposed at the vehicle exterior, the camera may be exposed to cold temperatures and temperature and humidity fluctuations, whereby moisture and/or ice or snow may form or collect at the lens. Further, the lens may be susceptible to dirt or debris collecting at the lens of the camera 14. This is particularly an issue for cameras mounted at the front of the vehicle, such as at a front bumper or grill or front fascia of the vehicle, or at the rear of the vehicle.

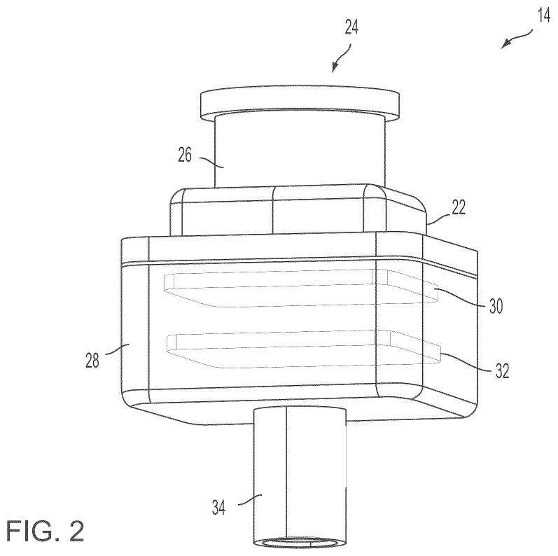

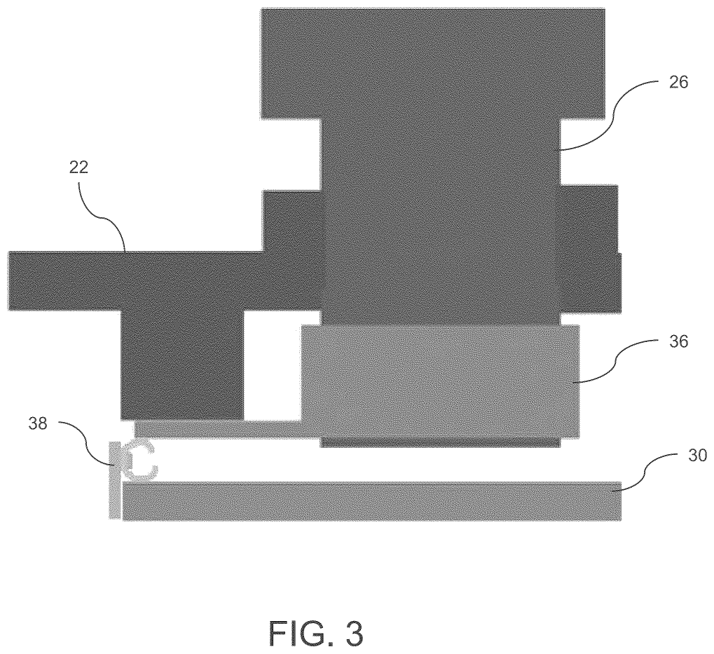

Referring to FIGS. 2-8, the camera 14 includes a lens holder or front housing portion 22, which supports or accommodates a lens assembly 24. The lens assembly 24 includes a lens barrel 26 (such as a cylindrical lens barrel) that houses or accommodates a lens having a plurality of lens optics or lens elements. The lens barrel 26 may comprise a metal lens barrel (or may comprise any suitable material, such as a plastic or polymeric or thermoplastic material or the like). Optionally, the lens barrel 26 is integrally formed with the lens holder 22. The camera 14 includes a rear housing portion 28 that is mated with the lens holder or front housing portion 22 to encase an imager printed circuit board (imager PCB) 30 (having the imager disposed thereat and aligned with the lens) and a connector printed circuit board (connector PCB) 32 therein. Optionally, the camera 14 includes a single PCB accommodating the imager and imaging circuitry and connector circuitry. The rear housing portion 28 includes a connector portion 34 (such as a coaxial connector) for electrically connecting the camera 14 to a wire harness or coaxial connector of the vehicle. The camera 14 includes a heating device 36 disposed at the lens barrel 26 and at least partially circumscribing the lens barrel.

The heating device 36 disposed at the lens barrel 26 may comprise any suitable heating device oriented within, integrated with, or at least partially circumscribing the lens barrel 26 and/or lens element. For example, the heating device 36 may be disposed at an inner portion of the lens barrel 26, such that the heating device 36 circumscribes an inner circumference or inner surface of the lens barrel 26 or the heating device 36 may be disposed at the lens accommodated by the lens barrel 26, or the heating device 36 may be disposed within a wall or integrated into the lens barrel 26. When the heating device 36 is electrically operated, the heating device 36 generates heat at the lens barrel 26 and/or one or more of the optic elements to defrost or defog or reduce or remove condensation from the lens element. The heating device and camera assembly may utilize characteristics of the camera assemblies described in U.S. Pat. No. 11,801,795 and/or U.S. Publication No. US-2025-0024125, which are hereby incorporated herein by reference in their entireties.

In some examples a heating device at a lens barrel of a vehicular camera includes two or more wires or electrical connectors coming from a bottom or inner end region of the lens. These wires may be difficult to position and control during focus and alignment of the camera. Connecting these wires to the camera PCB may be a manual operation that is prone to error or damage. Connection may be made automatically during camera assembly with spring contacts that accommodate the varying lens position from focus and alignment. However, spring fingers may put force on the circuit board which can change the focus or make the focus and align adhesive cure more difficult. As discussed further below, the heating device 36 may be electrically connected to a power source of the camera 14 via an electrical contact bridge 38 connected between electrical contacts at the heating device 36 and the imager PCB 30, where the electrical contact bridge 38 is installed at the camera assembly after the lens is aligned and focused with the imager at the imager PCB 30 with the lens secured relative to the imager PCB 30 to prevent or preclude or reduce effects of the electrical contact bridge 38 on the focus and alignment of the camera.

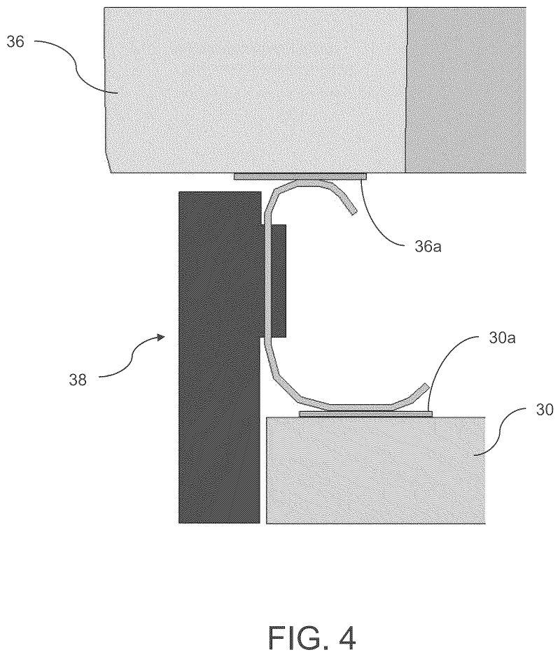

As shown in FIG. 4, the ends of the heater wires or electrical connectors may be terminated to flat contact pads 36a. In other words, the heating device 36 includes electrical terminals or contact pads 36a for electrically connecting the heating device at the lens to the power source of the camera. For example, the contact pads 36a may be adhered to a bottom side of the lens holder with a pressure sensitive adhesive or other fastening means. Contact pads or electrical terminals 30a may be disposed at the imager PCB 30 for electrically connecting to the contact pads 36a of the heating device 36. With the imager and the lens of the camera focused and aligned relative to one another, the contact pads 30a at the imager PCB 30 may be generally aligned with and spaced from the contact pads 36a of the heating device 36. That is, the contact pads 36a and the electrical terminals 30a may be generally aligned with one another in a direction parallel to the longitudinal axis of the lens barrel 26. The contact pads of the heating device and/or at the PCB may include flexible printed circuit (FPC) flat cable contacts.

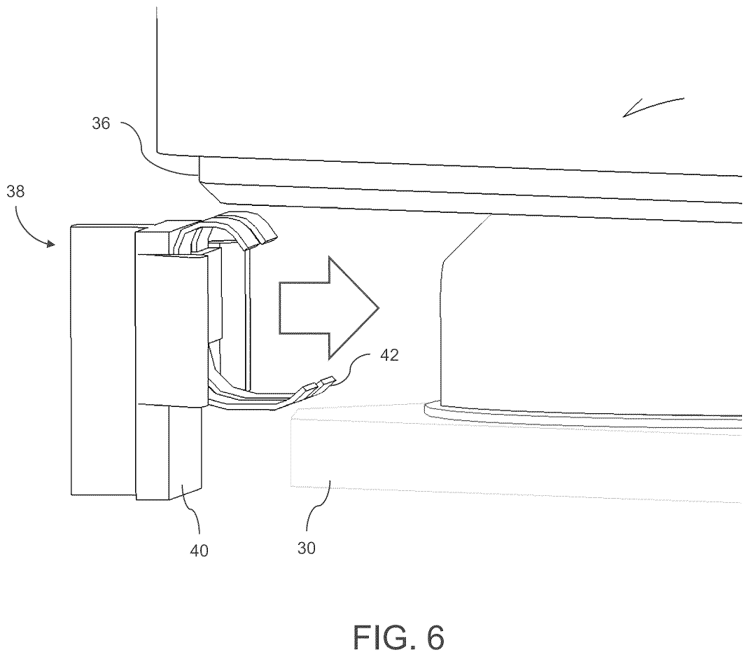

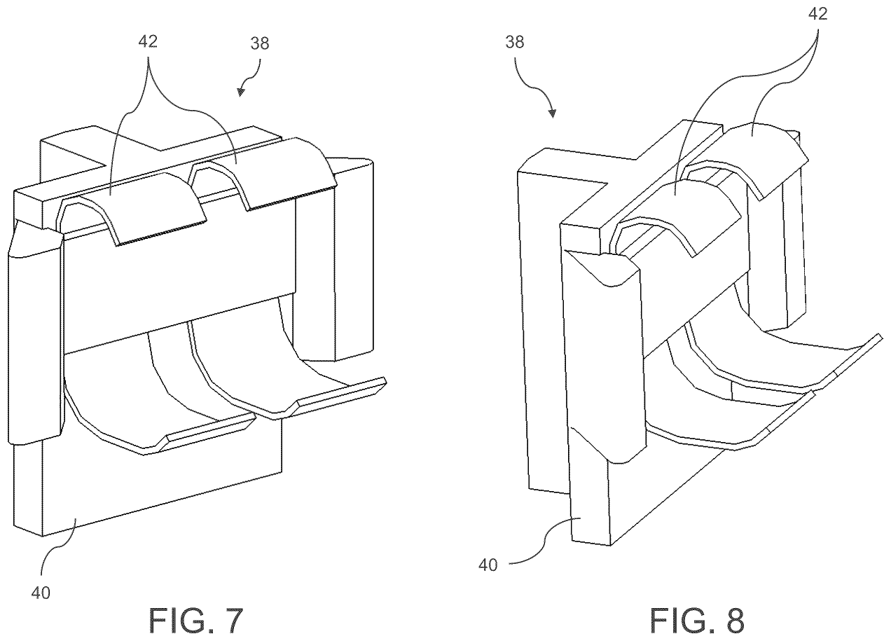

After the imager and the lens of the camera are focused and aligned relative to one another, and after an adhesive securing the lens relative to the imager is cured, the electrical contact bridge 38 is disposed between the PCB contact pads 30a and the contact pads 36a of the heating device 36 (FIG. 6). As shown in FIGS. 7 and 8, the electrical contact bridge 38 may include a rigid and non-conductive body or clip portion 40 with electrically conductive curved blade or spring contacts 42 disposed at the clip portion 40. In the illustrated example, the electrical contact bridge 38 accommodates two separate curved blades 42 (e.g., one for a positive electrical connection between first pads 30a, 36a and one for a negative or grounding electrical connection between second pads 30a, 36a). The curved blades 42 may be substantially C-shaped.

As the electrical contact bridge 38 is disposed between the PCB 30 and the heating device 36, the curved blades 42 may flex and apply a biasing force between the PCB 30 and the heating device 36 to maintain electrical contact between the pads 30a at the PCB 30 and the pads 36a of the heating device 36. Because the electrical contact bridge 38 is installed after a glue ring securing the lens relative to the imager is cured, this prevents or reduces forces from the springs 42 from bending the imager PCB and affecting the focus. The biasing force from the springs 42 may be about one Newton or less, with enough swipe length to accommodate varying positions of the PCB 30 relative to the heating device 36. Further, the pads 36a of the heating device 36 and the pads 30a at the PCB 30 may be sized to accommodate lateral PCB shift of the PCB 30 during active alignment.

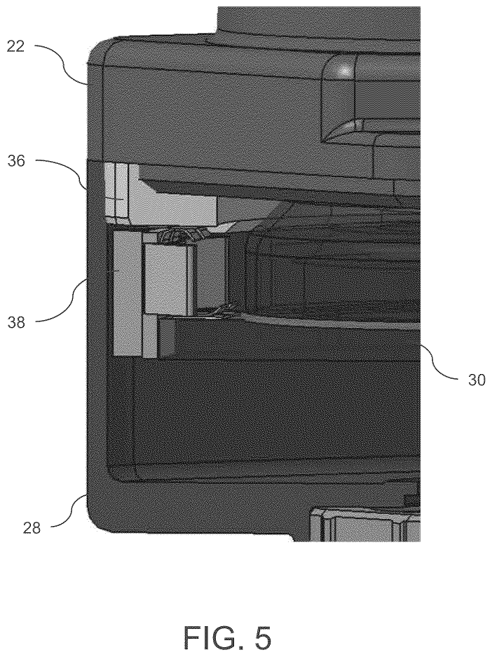

The clip portion 40 may be configured to secure the electrical contact bridge 38 relative to the PCB 30. For example, a corner of the PCB 30 may be cut or angled to correspond to an angle of the clip portion 40 so that the clip portion 40 is wedged or otherwise disposed between an edge of the PCB 30 and an inner surface of the rear housing portion 28 (FIG. 5). The clip portion 40 may snap attach to the PCB 30 and/or adhesively attach to the PCB 30 (e.g., to an edge region of the PCB 30).

Thus, during assembly of the camera, the imager at the imager PCB 30 may be focused with and aligned relative to the lens, and the lens may be secured relative to the imager PCB 30. For example, an adhesive ring may secure the lens barrel 26 at the imager PCB 30. After the adhesive ring is cured, the electrical contact bridge 38 is disposed between the imager PCB 30 and the contact pads 36a of the heating device 36 to electrically connect the heating device 36 to electrical circuitry at the imager PCB 30. The electrical contact bridge 38 includes curved spring blades or contacts 42 that electrically connect between the heating device 36 and the imager PCB 30 and that apply a biasing force between the imager PCB 30 and the heating device 36 to maintain electrical connect. Because the electrical contact bridge 38 is installed after the lens is secured relative to the imager, the biasing force does not affect focus or alignment of the lens and imager.

Thus, the camera includes a heating system (and optionally a washer system) that can be disposed at a vehicular camera (such as at and at least partially or entirely around or within a lens barrel of the camera) for heating the lens. The heating device, pins and camera may utilize aspects of the cameras and electrical connectors described in U.S. Pat. Nos. 10,484,587; 10,466,563; 9,878,669 and/or 9,565,342, which are hereby incorporated herein by reference in their entireties. The vehicular camera may utilize aspects of the cameras described in U.S. Publication Nos. US-2022-0089102; US-2022-0053112; US-2019-0113743; US-2018-0207691; US-2016-0272163 and/or US-2016-0264064, which are hereby incorporated herein by reference in their entireties.

Active focus and alignment may be used to set and secure a focal position of the lens relative to the imager component. For example, the imager PCB may be secured relative to the lens holder or front camera housing and the lens barrel may be attached (such as via threaded attachment) at the lens holder to set focus and alignment of the imager relative to the lens. The lens or lens barrel may be actively moved to set focus and alignment and an adhesive, such as an ultraviolet (UV) curable quick cure adhesive, may be used to secure the lens relative to the lens holder and the imager. Optionally, the camera may include a one piece lens assembly secured to the front camera housing and the imager PCB may be actively moved relative to the lens and front camera housing to set the focus, alignment and rotation of the imager relative to the lens. For example, alignment of the imager and lens may include characteristics of the processes and camera described in U.S. Publication Nos. US-2022-0373762 and/or US 2021-0382375, which are hereby incorporated herein by reference in their entireties.

The camera assembly or module may utilize aspects of the cameras and connectors described in U.S. Pat. Nos. 10,272,857; 10,250,004; 10,230,875; 10,142,532; 9,621,769; 9,277,104; 9,077,098; 8,994,878; 8,542,451 and/or 7,965,336, and/or U.S. Publication Nos. US-2009-0244361; US-2013-0242099; US-2014-0373345; US-2015-0124098; US-2015-0222795; US-2015-0327398; US-2016-0243987; US-2016-0268716;

US-2016-0286103; US-2016-0037028; US-2017-0129419; US-2017-0133811; US-2017-0201661; US-2017-0280034; US-2017-0295306 and/or US-2018-0098033, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774;

US-2014-0327772; US-2014-0320636; US-2014-0293057; US-2014-0309884; US-2014-0226012; US-2014-0293042; US-2014-0218535; US-2014-0218535; US-2014-0247354;

US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240;

US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular camera assembly, the vehicular camera assembly comprising:
a camera housing;
a lens barrel that accommodates a lens comprising a plurality of optical elements;
wherein the lens barrel is disposed at the camera housing;
an imager printed circuit board (imager PCB), wherein the imager PCB has a first side and a second side separated by a thickness of the imager PCB;
wherein an imager is disposed at the first side of the imager PCB;
a heating device disposed at the lens barrel, wherein the heating device includes an electrically connecting portion having electrical contact pads;
wherein electrical contacts are disposed at the first side of the imager PCB, and wherein the electrical contact pads are spaced from the electrical contacts at the first side of the imager PCB;
wherein the heating device is electrically connected to circuitry of the vehicular camera assembly via an electrical bridge contact that electrically connects between the electrical contact pads and the electrical contacts at the first side of the imager PCB;
wherein, during assembly of the vehicular camera assembly, (i) the imager is adjusted relative to the lens to align the imager and the lens, and (ii) the imager is secured relative to the lens when the imager is aligned with the lens;
wherein the electrical bridge contact is not disposed between the electrical contact pads and the first side of the imager PCB during adjustment of the imager relative to the lens and before the imager is secured relative to the lens, and wherein the electrical bridge contact is engaged with the electrical contact pads and the electrical contacts after the imager is aligned with the lens accommodated by the lens barrel and after the imager is secured relative to the lens;
wherein the electrical bridge contact comprises spring-loaded electrical connectors, and wherein, with the electrical bridge contact disposed between the electrical contact pads and the first side of the imager PCB, the spring-loaded electrical connectors (i) engage the electrical contact pads and the electrical contacts at the first side of the imager PCB and (ii) apply a biasing force between the electrical contact pads and the electrical contacts; and
wherein, when the heating device is electrically operated via the circuitry of the vehicular camera assembly, the heating device heats the lens accommodated by the lens barrel.

2. The vehicular camera assembly of claim 1, wherein the electrical bridge contact includes a clip portion that, with the electrical bridge contact disposed between the electrical contact pads and the first side of the imager PCB, attaches the electrical bridge contact at the imager PCB.

3. The vehicular camera assembly of claim 2, wherein the clip portion snap attaches the electrical bridge contact at the imager PCB.

4. The vehicular camera assembly of claim 2, wherein, with the electrical bridge contact disposed between the electrical contact pads and the first side of the imager PCB, the clip portion is disposed between an edge region of the imager PCB and an inner surface of the camera housing.

5. The vehicular camera assembly of claim 1, wherein the spring-loaded electrical connectors comprise C-shaped blades.

6. The vehicular camera assembly of claim 1, wherein a portion of the lens barrel is adhesively attached at the first side of the imager PCB to secure the imager PCB relative to the lens barrel.

7. The vehicular camera assembly of claim 6, wherein the electrical bridge contact is installed between the electrical contact pads and the electrical contacts after curing of adhesive attaching the portion of the lens barrel at the first side of the imager PCB.

8. The vehicular camera assembly of claim 1, wherein the camera housing includes a connecting portion that is configured to electrically connect the vehicular camera assembly to a wire harness connector of a vehicle when the vehicular camera assembly is disposed at the vehicle.

9. The vehicular camera assembly of claim 8, wherein the vehicular camera assembly is configured to be disposed at an exterior portion of the vehicle so as to have a field of view exterior of the vehicle.

10. A method for manufacturing a vehicular camera assembly, the method comprising:
adjusting an imager printed circuit board (imager PCB) and a lens barrel relative to one another to align an imager of the imager PCB with a lens accommodated by the lens barrel;
wherein the lens barrel is disposed at a camera housing, and wherein the lens comprises a plurality of optical elements;
wherein the imager PCB has a first side and a second side separated by a thickness of the imager PCB, and wherein the imager is disposed at the first side of the imager PCB;
with the imager aligned with the lens accommodated by the lens barrel, securing the imager PCB relative to the lens barrel to maintain alignment of the imager with the lens accommodated by the lens barrel;
wherein a heating device is disposed at the lens barrel, and wherein the heating device includes an electrically connecting portion having electrical contact pads;
wherein electrical contacts are disposed at the first side of the imager PCB, and wherein, with the imager aligned with the lens and the imager PCB secured relative to the lens barrel, the electrical contact pads are spaced from the electrical contacts at the first side of the imager PCB;
with the imager aligned with the lens and after the imager PCB is secured relative to the lens barrel, disposing an electrical bridge contact between the electrical contact pads and the electrical contacts at the first side of the imager PCB to electrically connect the heating device to circuitry of the vehicular camera assembly via the electrical bridge contact; and
wherein the electrical bridge contact comprises spring-loaded electrical connectors, and wherein, with the electrical bridge contact disposed between the electrical contact pads and the first side of the imager PCB, the spring-loaded electrical connectors (i) engage the electrical contact pads and the electrical contacts at the first side of the imager PCB and (ii) apply a biasing force between the electrical contact pads and the electrical contacts.

11. The method of claim 10, wherein, as the imager PCB and the lens barrel are adjusted relative to one another to align the imager of the imager PCB with the lens accommodated by the lens barrel, the electrical bridge contact is not disposed between the electrical contact pads and the electrical contacts at the first side of the imager PCB.

12. The method of claim 10, wherein the electrical bridge contact includes a clip portion that, with the electrical bridge contact disposed between the electrical contact pads and the first side of the imager PCB, attaches the electrical bridge contact at the imager PCB.

13. The method of claim 12, wherein disposing the electrical bridge contact between the electrical contact pads and the electrical contacts at the first side of the imager PCB comprises snap attaching the electrical bridge contact at the imager PCB via the clip portion.

14. The method of claim 12, wherein, with the electrical bridge contact disposed between the electrical contact pads and the first side of the imager PCB, the clip portion is disposed between an edge region of the imager PCB and an inner surface of the camera housing.

15. The method of claim 10, wherein the spring-loaded electrical connectors comprise C-shaped blades.

16. The method of claim 10, wherein securing the imager PCB relative to the lens barrel comprises adhesively attaching a portion of the lens barrel at the first side of the imager PCB.

17. The method of claim 16, wherein disposing the electrical bridge contact between the electrical contact pads and the electrical contacts at the first side of the imager PCB is after curing of adhesive attaching the portion of the lens barrel at the first side of the imager PCB.

18. A method for manufacturing a vehicular camera assembly, the method comprising:
adjusting an imager printed circuit board (imager PCB) and a lens barrel relative to one another to align an imager of the imager PCB with a lens accommodated by the lens barrel;
wherein the lens barrel is disposed at a camera housing, and wherein the lens comprises a plurality of optical elements;
wherein the imager PCB has a first side and a second side separated by a thickness of the imager PCB, and wherein the imager is disposed at the first side of the imager PCB;
with the imager aligned with the lens accommodated by the lens barrel, adhesively attaching a portion of the lens barrel at the first side of the imager PCB to secure the imager PCB relative to the lens barrel to maintain alignment of the imager with the lens accommodated by the lens barrel;
wherein a heating device is disposed at the lens barrel, and wherein the heating device includes an electrically connecting portion having electrical contact pads;
wherein electrical contacts are disposed at the first side of the imager PCB, and wherein, with the imager aligned with the lens and the imager PCB secured relative to the lens barrel, the electrical contact pads are spaced from the electrical contacts at the first side of the imager PCB;
with the imager aligned with the lens and after curing of adhesive attaching the portion of the lens barrel at the first side of the imager PCB, disposing an electrical bridge contact between the electrical contact pads and the electrical contacts at the first side of the imager PCB to electrically connect the heating device to circuitry of the vehicular camera assembly via the electrical bridge contact;
wherein the electrical bridge contact includes a clip portion that, with the electrical bridge contact disposed between the electrical contact pads and the first side of the imager PCB, attaches the electrical bridge contact at the imager PCB;
wherein, with the electrical bridge contact disposed between the electrical contact pads and the first side of the imager PCB, the clip portion is disposed between an edge region of the imager PCB and an inner surface of the camera housing; and
wherein the electrical bridge contact comprises spring-loaded electrical connectors, and wherein, with the electrical bridge contact disposed between the electrical contact pads and the first side of the imager PCB, the spring-loaded electrical connectors (i) engage the electrical contact pads and the electrical contacts at the first side of the imager PCB and (ii) apply a biasing force between the electrical contact pads and the electrical contacts.

19. The method of claim 18, wherein, as the imager PCB and the lens barrel are adjusted relative to one another to align the imager of the imager PCB with the lens accommodated by the lens barrel, the electrical bridge contact is not disposed between the electrical contact pads and the electrical contacts at the first side of the imager PCB.

20. The method of claim 18, wherein disposing the electrical bridge contact between the electrical contact pads and the electrical contacts at the first side of the imager PCB comprises snap attaching the electrical bridge contact at the imager PCB via the clip portion.
